(19) United States
(12) Patent Application Publication
(10) Pub. No.: US 2013/0048834 A1
(43) Pub. Date: Feb. 28, 2013

(54) INPUT DEVICE

(71) Applicants: Toru Mizutani, Ibaraki-shi (JP); Naoki Shibata, Ibaraki-shi (JP); Yusuke Shimizu, Ibaraki-shi (JP); Kei Nakamura, Ibaraki-shi (JP)

(72) Inventors: Toru Mizutani, Ibaraki-shi (JP); Naoki Shibata, Ibaraki-shi (JP); Yusuke Shimizu, Ibaraki-shi (JP); Kei Nakamura, Ibaraki-shi (JP)

(73) Assignee: NITTO DENKO CORPORATION, Osaka (JP)

(21) Appl. No.: 13/593,863

(22) Filed: Aug. 24, 2012

Related U.S. Application Data
(60) Provisional application No. 61/532,246, filed on Sep. 8, 2011.

(30) Foreign Application Priority Data
Aug. 29, 2011 (JP) 2011-185883
Jun. 8, 2012 (JP) 2012-130710

(51) Int. Cl. G01J 1/44

(52) U.S. Cl. 250/208.2; 250/206

(57) ABSTRACT

The input device includes a frame-shaped optical waveguide having a hollow input-use interior, and a control means provided on the outside of one of the sides of the optical waveguide. The optical waveguide and the control means are provided on a surface of a frame-shaped retainer plate. The control means includes: a light-emitting element connected to ends of light-emitting cores of the optical waveguide; a light-receiving element connected to ends of light-receiving cores of the optical waveguide; and a CPU incorporating a program. Upon sensing a first light-shielded area where light is intercepted by the tip of a pen and a second light-shielded area where light is intercepted by user's hand that holds the pen, the program recognizes the second light-shielded area larger than the first light-shielded area as unnecessary information, based on a difference in light-shielded area.

### RELATED APPLICATIONS

This application claims the benefit of U.S. Provisional Application No. 61/532,246 filed on Sep. 8, 2011, which is hereby incorporated by reference.

### FIELD OF THE INVENTION

The present invention relates to an input device including an optical position detection means.

### BACKGROUND OF THE INVENTION

Conventionally, an optical position detection device (see Japanese Patent No. 3682109, for example) including a plurality of light-emitting elements and a plurality of light-receiving elements is proposed as an input device. This optical position detection device is in the form of a rectangular frame comprised of a pair of L-shaped sections. The light-emitting elements are disposed in juxtaposition in one of the L-shaped sections of the rectangular frame, and the light-receiving elements opposed to the aforementioned light-emitting elements are disposed in juxtaposition in the other L-shaped section thereof. The rectangular frame-shaped optical position detection device is placed along the periphery of a rectangular display. Information such as a character is inputted to the optical position detection device and is caused to appear on the aforementioned display by moving a pen within the rectangular frame of the optical position detection device.

Specifically, the aforementioned light-emitting elements cause light beams to travel in a lattice form within the aforementioned rectangular frame. When a pen is moved within the rectangular frame, some of the light beams emitted from the aforementioned light-emitting elements are intercepted by the tip of the pen. The light-receiving elements opposed to the aforementioned light-emitting elements sense the interception of light beams to thereby detect the path of the aforementioned pen tip (input information such as a character). The path is outputted as a signal to the aforementioned display.

However, the aforementioned rectangular frame-shaped optical position detection device, which is placed along the periphery of the aforementioned display, has a wide area within the aforementioned rectangular frame. For this reason, when a user makes an attempt to input a character and the like within the aforementioned rectangular frame with the aforementioned pen, not only the pen tip but also a little finger of his/her hand that holds the pen, the base of the little finger (such as a hypothenar) and the like come into contact with the surface of the aforementioned display within the aforementioned rectangular frame. In this case, the optical position detection device detects all of the parts in contact with the surface of the aforementioned display within the aforementioned rectangular frame to present a problem in that unnecessary parts (the aforementioned little finger, the base thereof and the like) are sensed, whereby such unnecessary information also appears on the aforementioned display. When the user makes an attempt to input a character and the like with the aforementioned pen so as not to bring the aforementioned little finger, the base thereof and the like into contact with the surface of the aforementioned display, another problem arises in that the character and the like become messy and the user cannot properly perform the input operation.

### SUMMARY OF THE INVENTION

An input device is provided which is capable of rejecting information about an unnecessary part such as a little finger of user's hand that holds a pen, upon sensing the unnecessary part during the operation of inputting information such as a character with the pen.

An input device comprises: a frame-shaped plate comprising a frame surrounding a space serving as a hollow input-use interior for input with an input element held by a hand, the frame-shaped plate including a pair of sections opposed to each other; a light-emitting means provided on a first one of the opposed sections of the frame-shaped plate; and a light-receiving means provided on a second one of the opposed sections of the frame-shaped plate and for receiving light beams emitted from the light-emitting means, the input device being configured such that the emitted light beams travel in a lattice form within the hollow input-use interior and such that some of the emitted light beams are intercepted by a tip input part of the input element within the hollow input-use interior to provide input information, the input device further comprising an unnecessary part recognizing means for recognizing a larger light-shielded part as unnecessary information, based on a difference in light-shielded area, upon sensing a first light-shielded area where some of the emitted light beams are intercepted by the tip input part of the input element and a second light-shielded area where some of the emitted light beams are intercepted by the hand, the second light-shielded area being larger than the first light-shielded area.

In the input device, when a user holds the input element such as a pen in his/her hand in the hollow input-use interior and inputs information such as a character into a region within the hollow input-use interior, the little finger and the like of the aforementioned hand which are unnecessary for input information are also sensed together with the tip input part such as a pen tip. However, the input device, which includes the unnecessary part recognizing means, is capable of distinguishing between the tip input part having a small light-shielded area and the little finger and the like of user's hand having a large light-shielded area (an unnecessary part), based on the difference in light-shielded area, to thereby recognize the light-shielded part having a larger light-shielded area as unnecessary information. Base on this recognition, the unnecessary information is rejected, for example so as not to appear on a display or not to be stored in the form of data.

In particular, when the light-shielded area having a length of not less than 5 mm is determined as the unnecessary information, the pen tip (the tip input part) and the like of a generally commercially available pen (the input element) is recognized as distinguished from the little finger and the like of the hand (the unnecessary part) even when the pen and the like are used in a slanting position.

Further, when the input device further comprises a misrecognition preventing means for judging a light-shielded part of a hand in the air as a misrecognition, and for thereby recognizing the light-shielded part of the input element as an input information, when a light-shielded part of a tip input part of an input element and the light-shielded part of the hand in the air smaller than the light-shielded part of the tip input part of the input element are sensed, based on a positional difference of the light-shielded parts, the positional difference being such that the light-shielded part of the hand in the air is apart from a pre-recognized light-shielded part of the input element by more than a predetermined distance while the light-shielded part of the input element is within the predetermined distance from the pre-recognized light-shielded part of the input element, the input device can properly recognize the light-shielded parts of the tip input part of the input element by the positional difference of the light-shielded parts even when the hand is suspended in the air and thus the light-shielded parts of the hand become smaller than the light-shielded part of the tip input part of the input element.

Also, the light-emitting means includes a light-emitting element, and a plurality of light-emitting cores of an optical waveguide, the light-emitting cores being connected to the light-emitting element; the light-receiving means includes a light-receiving element, and a plurality of light-receiving cores of the optical waveguide, the light-receiving cores being connected to the light-receiving element; and tips of the light-emitting cores and tips of the light-receiving cores are opposed to each other while being positioned on inner edges of the frame-shaped plate. In such a case, the aforementioned optical waveguide is formed on the aforementioned frame-shaped plate, and the optical waveguide is made thin. Thus, when a user performs an input operation with the input element, the input device according to the present invention does not serve as an impediment to the use of the input element. This facilitates the input operation.

On the other hand, the light-emitting means includes a plurality of light-emitting elements; the light-receiving means includes a plurality of light-receiving elements; and the light-emitting elements and the light-receiving elements are opposed to each other while being positioned on inner edges of the frame-shaped plate. In such a case, the aforementioned light-emitting elements and the aforementioned light-receiving elements have a certain amount of thickness, and the input device according to the present invention accordingly has a certain amount of thickness as a whole. This allows the input device to have a certain amount of rigidity and strength.

### BRIEF DESCRIPTION OF THE DRAWINGS

FIG. 1 is a perspective view schematically showing an input device according to one preferred embodiment.

FIG. 2A is a plan view schematically showing an optical waveguide for the input device.

FIG. 2B is a sectional view, on an enlarged scale, taken along the line X1-X1 of FIG. 2A.

FIG. 2C is a sectional view, on an enlarged scale, taken along the line X2-X2 of FIG. 2A.

FIG. 3 is a flow diagram illustrating a program for a CPU of the input device.

FIGS. 4A to 4C are views schematically illustrating an exemplary method of producing the input device.

FIGS. 5A to 5C are views schematically illustrating the method of producing the input device subsequent to the steps shown in FIGS. 4A to 4C.

FIGS. 6A and 6B are views schematically illustrating the method of producing the input device subsequent to the steps shown in FIGS. 5A to 5C.

FIG. 7A is a view schematically illustrating the method of producing the input device subsequent to the steps shown in FIGS. 6A and 6B.

FIG. 7B is a sectional view taken along the line X3-X3 of FIG. 7A.

FIG. 8 is a view schematically illustrating the method of producing the input device subsequent to the steps shown in FIGS. 7A and 7B.

FIG. 9 is a view schematically illustrating an assumed operation of an input device according to another preferred embodiment.

FIG. 10 is a plan view schematically showing an exemplary case where input information is misrecognized.

FIG. 11 is a plan view schematically showing an input device according to still another preferred embodiment.

### DETAILED DESCRIPTION OF THE INVENTION

Next, preferred embodiments according to the present invention will now be described in detail with reference to the drawings.

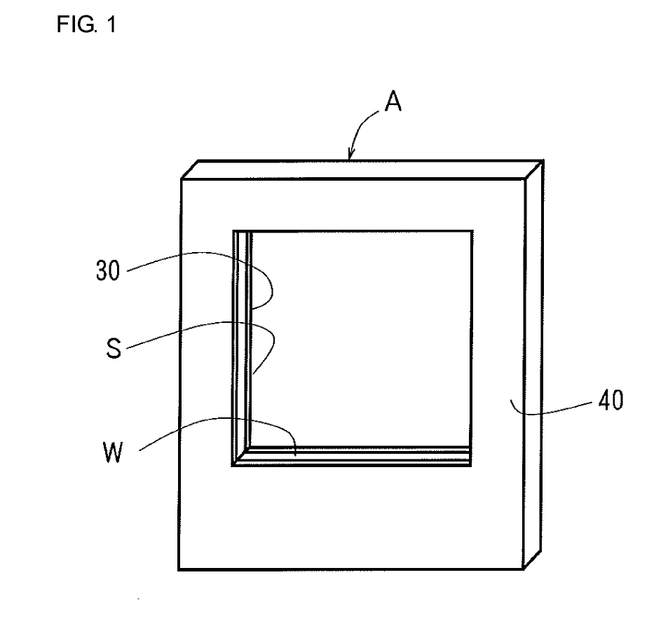

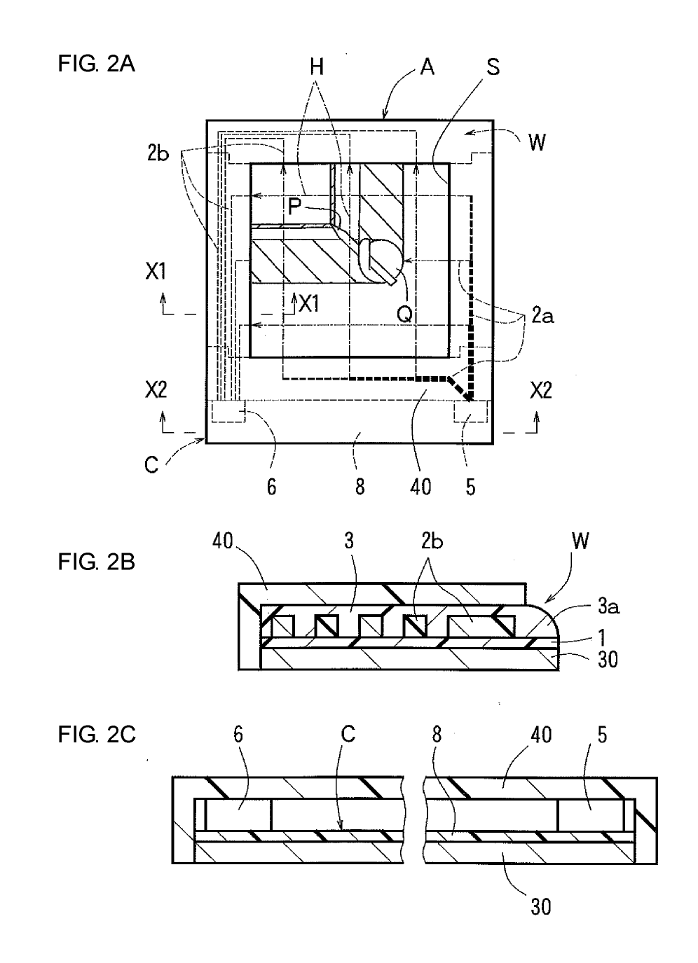

FIG. 1 is a perspective view showing an input device according to one preferred embodiment. FIG. 2A is a plan view of the input device. FIG. 2B is a sectional view, on an enlarged scale, taken along the line X1-X1 of FIG. 2A. FIG. 2C is a sectional view, on an enlarged scale, taken along the line X2-X2 of FIG. 2A. As shown in FIG. 1, the input device A according to this preferred embodiment is in the form of a rectangular frame having a rectangular hollow input-use interior (window) S. As shown in FIGS. 2A and 2B, the input device A incorporates a rectangular frame-shaped optical waveguide W having the aforementioned hollow input-use interior S, and a control means C having a light-emitting element 5 and a light-receiving element 6 which are connected to this optical waveguide W. The optical waveguide W and the control means C are provided on a surface of a rectangular frame-shaped retainer plate (frame-shaped plate) 30 having the aforementioned hollow input-use interior S, and are covered with a rectangular frame-shaped protective plate 40 having the aforementioned hollow input-use interior S. Light beams H from the aforementioned light-emitting element 5 pass through light-emitting cores 2a of the aforementioned optical waveguide W and are emitted in a horizontal direction (a direction from right to left as viewed in FIG. 2A) and in a vertical direction (a direction from bottom to top as viewed in FIG. 2A) to travel in a lattice form in a region within the aforementioned hollow input-use interior S.

The aforementioned control means C further includes a CPU (central processing unit) (not shown) for controlling the aforementioned input device A, in addition to the aforementioned light-emitting element 5 and the light-receiving element 6. The CPU incorporates a program (unnecessary part recognizing means) for recognizing a larger light-shielded part as unnecessary information, based on a difference in light-shielded area, upon sensing a first light-shielded area (a vertical dimension and a horizontal dimension of a light-shielded part) where some of the aforementioned light beams H are intercepted by a pen tip (a tip input part) of a pen (an input element) P and a second light-shielded area larger (at least one of the vertical and horizontal dimensions of a light-shielded part is larger) than the first light-shielded area (or the second light-shielded area where some of the aforementioned light beams H are intercepted by a little finger and the like of user's hand Q that holds the pen P) within the hollow input-use interior S.

This will be described in further detail. As shown in FIGS. 2A and 2B, the aforementioned rectangular frame-shaped optical waveguide W is configured such that strip-shaped optical waveguide sections corresponding to the respective sides of the rectangular frame shape of the optical waveguide W are produced individually and then are connected together into the shape of the rectangular frame. In this preferred embodiment, opposite end edges of each of the strip-shaped optical waveguide sections have step portions. Adjacent optical waveguide sections, which are positioned relative to each other using the step portions, are connected to each other. Each of the strip-shaped optical waveguide sections includes an under cladding layer 1, the light-emitting cores 2a and light-receiving cores 2b formed in a predetermined pattern on a surface of the under cladding layer 1, and an over cladding layer 3 formed on the surface of the aforementioned under cladding layer 1 so as to cover the cores 2a and 2b. The aforementioned under cladding layer 1 is affixed to the surface of the aforementioned rectangular frame-shaped retainer plate 30. The light-emitting cores 2a are not shown in FIG. 2B because FIG. 2B is a sectional view on the light-receiving side.

In the aforementioned optical waveguide W in the form of a rectangular frame, the under cladding layer 1 is in the form of a rectangular frame comprised of a pair of L-shaped sections. The light-emitting cores 2a are disposed in a divided manner on the surface of one of the L-shaped sections, and the light-receiving cores 2b are disposed in juxtaposition on the surface of the other L-shaped section. The cores 2a and 2b have respective tips positioned on the inner edges of the aforementioned pair of L-shaped sections (the inner peripheral edges of the rectangular frame). The tips of the light-emitting cores 2a are in an opposed relationship with the tips of the light-receiving cores 2b. The over cladding layer 3 in the form of a rectangular frame is formed on the surface of the aforementioned under cladding layer 1 so as to cover the aforementioned light-emitting cores 2a and the light-receiving cores 2b. In this preferred embodiment, each of the tips of the cores 2a and 2b positioned on the inner peripheral edges of the aforementioned rectangular frame is in the form of a convex lens portion having a substantially semicircular curved surface as seen in plan view, and an edge portion of the over cladding layer 3 covering the lens portions is in the form of a convex lens portion 3a having a partially spherical curved lens surface. In FIG. 2A, the cores 2a and 2b are indicated by broken lines, and the thickness of the broken lines indicates the width of the cores 2a and 2b. Also, in FIGS. 2A and 2B, the number of cores 2a and 2b are shown as abbreviated.

On the other hand, the aforementioned control means C further includes an output module (not shown) for outputting information inputted in the region within the hollow input-use interior S of the aforementioned optical waveguide W (information about the movement path of the pen tip), a storage means (not shown) for storing the information therein, a battery (not shown) serving as a power source, and the like, in addition to the light-emitting element 5, the light-receiving element 6 and the CPU described earlier. The aforementioned light-emitting element 5, the aforementioned light-receiving element 6, the aforementioned CPU, the aforementioned output module, the aforementioned storage means, the aforementioned battery and the like are mounted on a circuit board, and are electrically connected. As shown in FIGS. 2A and 2C, the aforementioned light-emitting element 5 is connected to ends of the plurality of light-emitting cores 2a of the aforementioned optical waveguide W, and the aforementioned light-receiving element 6 is connected to ends of the plurality of light-receiving cores 2b of the aforementioned optical waveguide W.

As mentioned earlier, the aforementioned CPU incorporates the program for recognizing a larger light-shielded part as unnecessary information, based on a difference in light-shielded area, upon sensing a first light-shielded area where some of the aforementioned light beams H are intercepted by the pen tip and a second light-shielded area larger than the first light-shielded area (or the second light-shielded area where some of the aforementioned light beams H are intercepted by a little finger and the like of user's hand Q that holds the pen P) within the hollow input-use interior S. Specifically, the little finger and the like of user's hand Q that holds the aforementioned pen P which are unnecessary for the input information are also sensed during an input operation into the aforementioned hollow input-use interior S with the pen P. However, the program incorporated in the aforementioned CPU is capable of distinguishing between the pen tip having a small light-shielded area and the little finger and the like of user's hand Q having a large light-shielded area (the unnecessary part), based on the difference in light-shielded area, to thereby recognize the light-shielded part having a larger light-shielded area as unnecessary information. Based on this recognition, the unnecessary information is rejected, for example so as not to appear on a display or not to be stored in the form of data.

The position of the aforementioned light-shielded area may be judged from the position where the amount of change in detection voltage from the light-receiving element 6 reaches a peak. Thus, the input device A shown in FIG. 2A may judge the aforementioned peak at the leftmost and uppermost position as the pen tip when the user is right-handed (or the peak at the rightmost and uppermost position as the pen tip when the user is left-handed). Also, the aforementioned light-shielded area may be judged from the width of the aforementioned peak. Thus, when the left hand or the like of a right-handed user who is using the aforementioned input device A is sensed in the aforementioned hollow input-use interior S, an object having the smallest peak width may be judged as the pen tip.

At the moment when the aforementioned hand Q begins to be sensed, the aforementioned peak width becomes small in some cases, so that there is a danger that the hand Q is misrecognized as the pen tip. To prevent this, an addition may be made to the program incorporated in the aforementioned CPU so that any object sensed for a short fixed time period at the beginning of the sensing is ignored, whether it be the pen tip or the hand Q. Alternatively, an addition may be made to the program incorporated in the aforementioned CPU so that, even if the aforementioned hand Q at the beginning of the sensing is misrecognized as the pen tip and is displayed on the display, the aforementioned display or the like is erased at the moment when the displayed object is recognized as the aforementioned hand Q.

Also, if there is a foreign substance or the like within the hollow input-use interior S, the foreign substance or the like is sensed as an object similar to the pen tip. Thus, when an input operation is done with the pen P in that state, two or more objects are sensed. An addition may be made to the program incorporated in the aforementioned CPU so that an alarm is issued in such a case. This informs a user that the foreign substance or the like is present within the aforementioned hollow input-use interior S. Further, when the input device A is used in a very bright environment (outdoors, for example), intense external light enters the tips of the light-receiving cores 2b although the pen tip or the like intercepts light beams. As a result, the pen tip (the light-shielded area) cannot be sensed in some cases. To prevent this, an addition may be made to the program incorporated in the aforementioned CPU so that an alarm is issued when such intense light is sensed.

In the input device A including the optical waveguide W and the control means C having such a configuration, light beams H from the aforementioned light-emitting element 5 pass through the aforementioned light-emitting cores 2a and through the lens portions at the tips of the respective light-emitting cores 2a, and then exit the surface of the lens portion 3a of the over cladding layer 3 covering the lens portions of the respective light-emitting cores 2a. Upon exiting, the light beams H travel in a lattice form in the region within the hollow input-use interior S of the aforementioned rectangular frame-shaped optical waveguide W, as described earlier. The light beams H traveling in a lattice form are restrained from diverging by refraction through the lens portions at the tips of the aforementioned light-emitting cores 2a and through the lens portion 3a of the over cladding layer 3 covering the lens portions of the cores 2a. The aforementioned light beams H are transmitted through the lens portion 3a on a light-receiving side of the over cladding layer 3 and through the lens portions at the tips of the respective light-receiving cores 2b. Then, the light beams H pass through the aforementioned light-receiving cores 2b to reach the aforementioned light-receiving element 6. The light beams entering the aforementioned light-receiving cores 2b are narrowed down and converged by refraction through the lens portion 3a of the aforementioned over cladding layer 3 and through the lens portions at the tips of the aforementioned light-receiving cores 2b.

An example of the input of information by means of the aforementioned input device A is as follows. A user places the aforementioned input device A on a paper sheet, holds the pen P in his/her hand Q, and writes a character, a drawing, a mark or the like with the aforementioned pen P on part of the aforementioned paper sheet revealed within the hollow input-use interior S where the light beams H travel in the lattice form as mentioned above. During the writing operation, some of the light beams H traveling in the aforementioned lattice form are intercepted by the pen tip of the aforementioned pen P and the aforementioned hand Q. The aforementioned light-receiving element 6 senses the interception of light beams to thereby detect the path of the aforementioned pen tip and the position of the aforementioned hand Q. The path of the pen tip serves as input information such as a character, a drawing, a mark or the like.

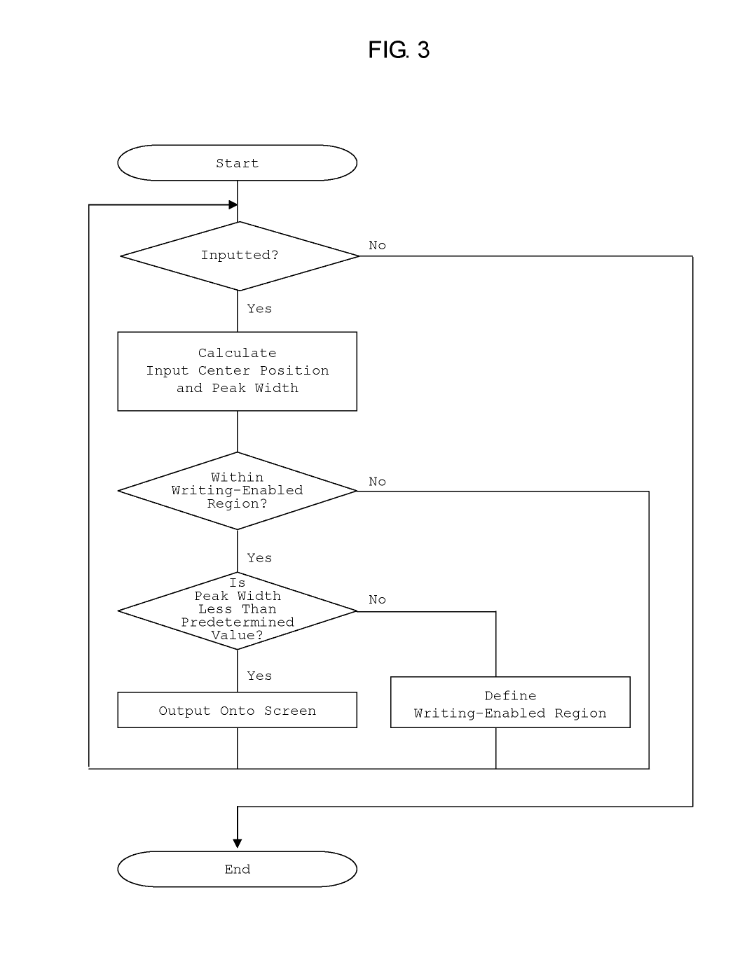

In this preferred embodiment, the program incorporated in the CPU of the aforementioned control means C effects control, for example, as shown in the aforementioned flow diagram of FIG. 3. Specifically, when the user holds the pen P in his/her hand Q, and writes a character, a drawing, a mark or the like with the pen P on part of the paper sheet revealed within the hollow input-use interior S as mentioned above, light-shielded parts are formed by the pen tip of the pen P and the aforementioned hand Q. The aforementioned light-receiving element 6 senses the light-shielded parts. The center position of the pen tip and the hand Q is judged from the peak width of the amount of change in the detection voltage from the aforementioned light-receiving element 6, and the size (or width) of the pen tip and the hand Q (a predetermined value from the center) is determined. Then, whether the aforementioned pen tip and the aforementioned hand Q lie within a writing-enabled region or not is judged. This writing-enabled region refers to a region lying to the left of and above the aforementioned hand Q for a right-handed user, and refers to a region lying to the right of and above the aforementioned hand Q for a left-handed user. It should be noted that the entire hollow input-use interior S is defined as the writing-enabled region at the start. Next, if the aforementioned pen tip and the aforementioned hand Q lie within the writing-enabled region, a judgment is made as to whether the size of the pen tip and the hand Q (the aforementioned peak width) is less than a predetermined value or not. An object having the aforementioned size less than the predetermined value is recognized as the pen tip, and the path of the pen tip is displayed as input information on a display. An object having the aforementioned size not less than the predetermined value is recognized as the hand (unnecessary information) Q, and is not displayed on the display. Thereafter, a new writing-enabled region is defined. It is preferable that the aforementioned predetermined value is 5 mm from the viewpoint of easily distinguishing between the pen tip of a generally commercially available pen and the hand Q.

Such an input device A is used together with, for example, a personal computer (referred to hereinafter as a “PC”). Specifically, when information such as a document is displayed on a display for the aforementioned PC and a user adds information such as a character, a drawing and a mark to the displayed information, the user inputs the information such as a character into the region within the hollow input-use interior S of the aforementioned input device A with the pen P as described above. In response to the input operation, the aforementioned input device A detects the path of the pen tip, and transmits the path as a signal to the aforementioned PC by radio or through a connecting cable, so that the information appears on the aforementioned display. The information such as a character inputted by means of the aforementioned input device A which is superimposed on the aforementioned information such as a document appears on the aforementioned display.

Software (a program) for converting coordinates in the region within the hollow input-use interior S of the input device A into coordinates on the screen of the display to display a character or the like inputted by means of the input device A on the display is incorporated in the aforementioned PC used herein for the purpose of displaying the character or the like inputted in the hollow input-use interior S of the aforementioned input device A in a position on the display corresponding to the input position.

It should be noted that the aforementioned information such as a document is, in general, previously stored in an information storage medium such as a hard disk in the aforementioned PC and an external USB memory device, and is outputted from the information storage medium. The information appearing on the aforementioned display which is the superimposition of the information such as a character inputted by means of the aforementioned input device A on the aforementioned information such as a document may be stored in the aforementioned information storage medium.

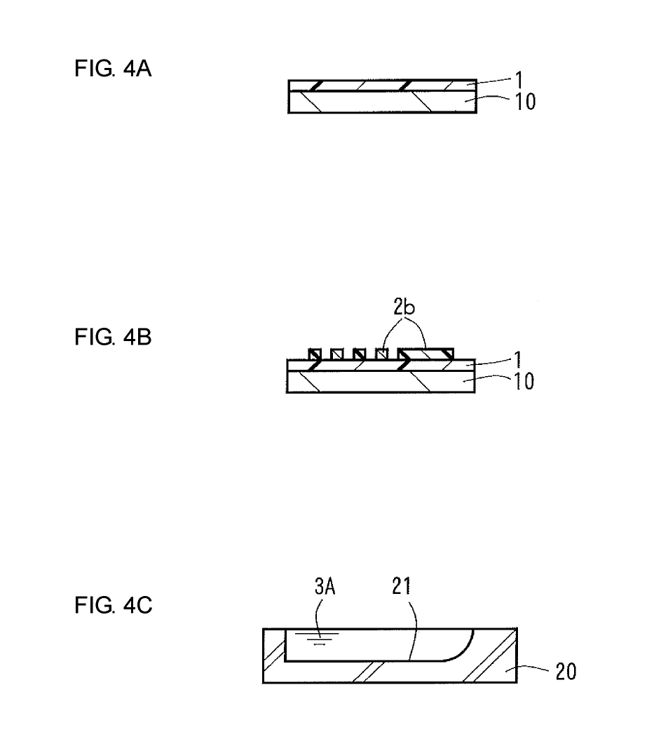

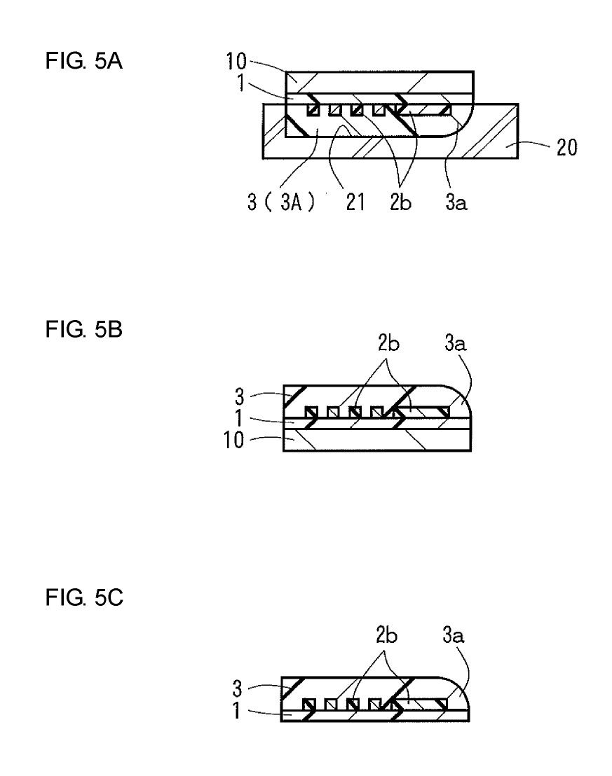

Next, an exemplary method of producing the aforementioned input device A will be described. In this preferred embodiment, the rectangular frame-shaped optical waveguide W is produced by individually producing the strip-shaped optical waveguide sections corresponding to the respective sides of the rectangular frame shape of the optical waveguide W and then connecting the strip-shaped optical waveguide sections together into the shape of the rectangular frame. It should be noted that FIGS. 4A to 4C, and 5A to 5C referenced for description on the method of producing the optical waveguide W show portions corresponding to a cross section taken along the line X1-X1 of FIG. 2A.

First, a substrate 10 for the formation of each of the strip-shaped optical waveguide sections (with reference to FIG. 4A) is prepared. Examples of a material for the formation of this substrate 10 include metal, resin, glass, quartz, and silicon.

Then, as shown in FIG. 4A, the strip-shaped under cladding layer 1 is formed on a surface of the substrate 10. This under cladding layer 1 may be formed by a photolithographic method using a photosensitive resin as a material for the formation thereof. The under cladding layer 1 has a thickness in the range of 5 to 50 μm, for example.

Next, as shown in FIG. 4B, the light-emitting cores 2a and the light-receiving cores 2b which have the aforementioned pattern are formed on a surface of the aforementioned under cladding layer 1 by a photolithographic method. Pitches between tips of the cores 2a and pitches between tips of the cores 2b (pitches of the light H within the hollow input-use interior S) are preferably small and may be set, for example, within the range from 0.05 to 0.45 mm from the view point of improving accuracy of positional detection of a pen tip. An example of a material for the formation of the cores 2a and 2b used herein includes a photosensitive resin having a refractive index higher than that of the materials for the formation of the aforementioned under cladding layer 1 and the over cladding layer 3 to be described below (with reference to FIG. 5B). The light-emitting cores 2a are not shown in FIG. 4B because FIG. 4B is a sectional view on the light-receiving side. The same applies to FIGS. 5A to 5C to be described later.

As shown in FIG. 4C, a light-transmissive mold 20 for the formation of the over cladding layer 3 is prepared. The mold 20 includes a cavity 21 having a mold surface complementary in shape to the surface of the over cladding layer 3 (with reference to FIG. 5B). The mold 20 is placed on a molding stage (not shown), with the cavity 21 positioned to face upward. Then, the cavity 21 is filled with a photosensitive resin 3A serving as the material for the formation of the over cladding layer 3.

Then, as shown in FIG. 5A, the cores 2a and 2b patterned on the surface of the aforementioned under cladding layer 1 are positioned relative to the cavity 21 of the aforementioned mold 20. In that state, the aforementioned under cladding layer 1 is pressed against the aforementioned mold 20, so that the aforementioned cores 2a and 2b are immersed in the photosensitive resin 3A serving as the material for the formation of the aforementioned over cladding layer 3. In this state, the aforementioned photosensitive resin 3A is exposed to irradiation light such as ultraviolet light by directing the irradiation light through the aforementioned mold 20 onto the aforementioned photosensitive resin 3A. This exposure cures the aforementioned photosensitive resin 3A to form the over cladding layer 3 in which part of the over cladding layer 3 corresponding to the tips of the cores 2a and 2b is formed as the lens portion 3a.

Next, as shown in FIG. 5B (shown in an orientation vertically inverted from that shown in FIG. 5A), the aforementioned over cladding layer 3 together with the aforementioned substrate 10, the under cladding layer 1, and the cores 2a and 2b is removed from the aforementioned mold 20 (with reference to FIG. 5A).

Then, as shown in FIG. 5C, the aforementioned substrate 10 (with reference to FIG. 4B) is stripped from the under cladding layer 1. This provides each of the strip-shaped optical waveguide sections including the under cladding layer 1, the cores 2a and 2b, and the over cladding layer 3.

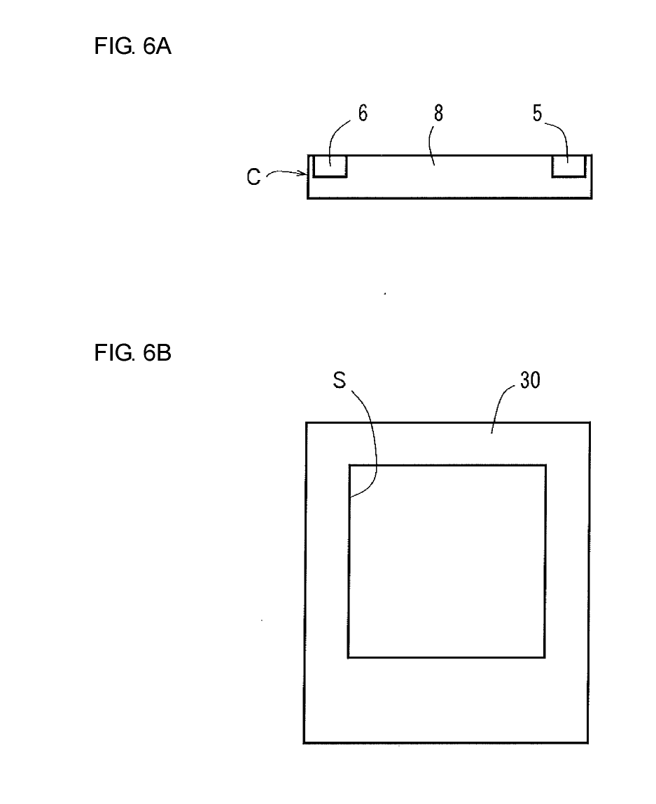

Next, as shown in plan view in FIG. 6A, a circuit board 8 is prepared, and the aforementioned control means C is produced by mounting on the circuit board 8 the following parts: the light-emitting element 5, the light-receiving element 6, the CPU (not shown) for controlling the aforementioned input device A (with reference to FIG. 1), the output module (not shown) for outputting information inputted into the region within the hollow input-use interior S of the aforementioned optical waveguide W (with reference to FIG. 1), the aforementioned storage means (not shown), the battery (not shown), and the like.

The rectangular frame-shaped retainer plate 30 having the hollow input-use interior S is prepared, as shown in plan view in FIG. 6B. Examples of a material for the formation of the retainer plate 30 include metal, resin, glass, quartz, and silicon. In particular, stainless steel is preferable in that it has a good ability to hold its planarity. The retainer plate 30 has a thickness of approximately 0.5 mm, for example.

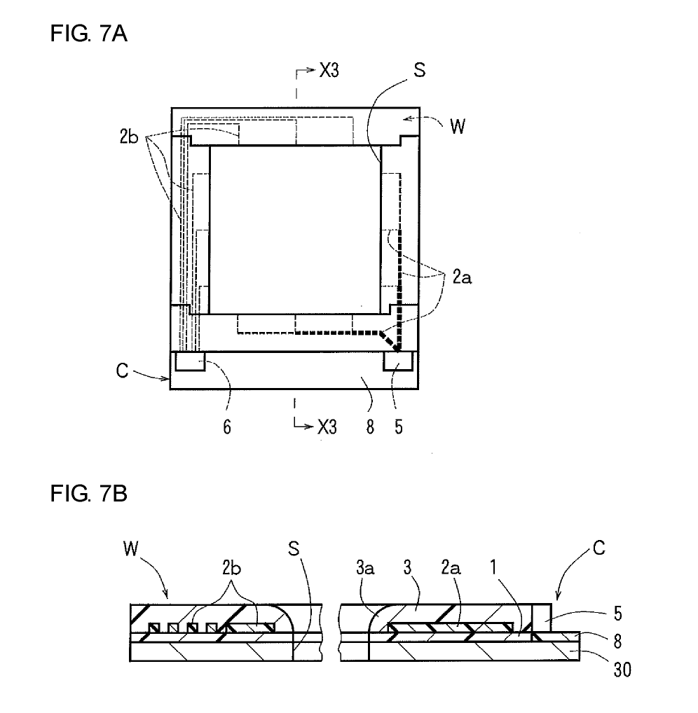

As shown in plan view in FIG. 7A and shown in sectional view (a sectional view taken along the line X3-X3 of FIG. 7A) in FIG. 7B, the aforementioned strip-shaped optical waveguide sections are affixed to the surface of the aforementioned rectangular frame-shaped retainer plate 30 to produce the rectangular frame-shaped optical waveguide W. At this time, the aforementioned light-emitting element 5 is connected to the light-emitting cores 2a, and the aforementioned light-receiving element 6 is connected to the light-receiving cores 2b.

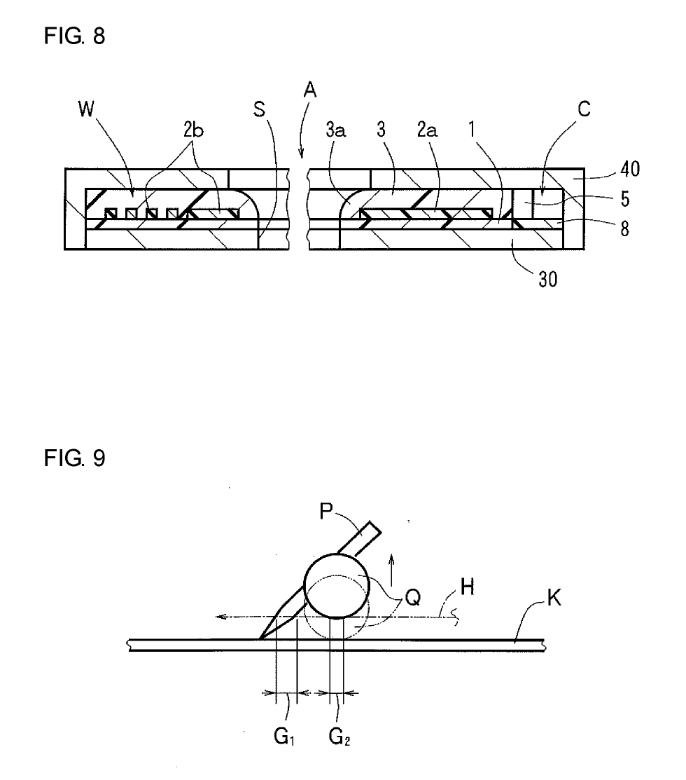

Thereafter, as shown in sectional view in FIG. 8, the top surface of the aforementioned over cladding layer 3 except the lens portion 3a, and the aforementioned control means C are covered with the protective plate 40. Examples of a material for the formation of the protective plate 40 include resin, metal, glass, quartz, and silicon. The protective plate 40 has a thickness of approximately 0.5 mm when made of metal, and approximately 0.8 mm when made of resin, for example.

In this manner, the aforementioned input device A is produced. Part of the input device A corresponding to the aforementioned optical waveguide W, together with the aforementioned retainer plate 30 and the protective plate 40 on the front and back surfaces thereof, is as thin as approximately 3 mm in total thickness. Part of the input device A corresponding to the aforementioned control means C, together with the aforementioned retainer plate 30 and the protective plate 40 on the front and back surfaces thereof, is as thin as approximately 3 mm in total thickness. In this preferred embodiment, the part corresponding to the aforementioned optical waveguide W and the part corresponding to the aforementioned control means C are equal in thickness to each other.

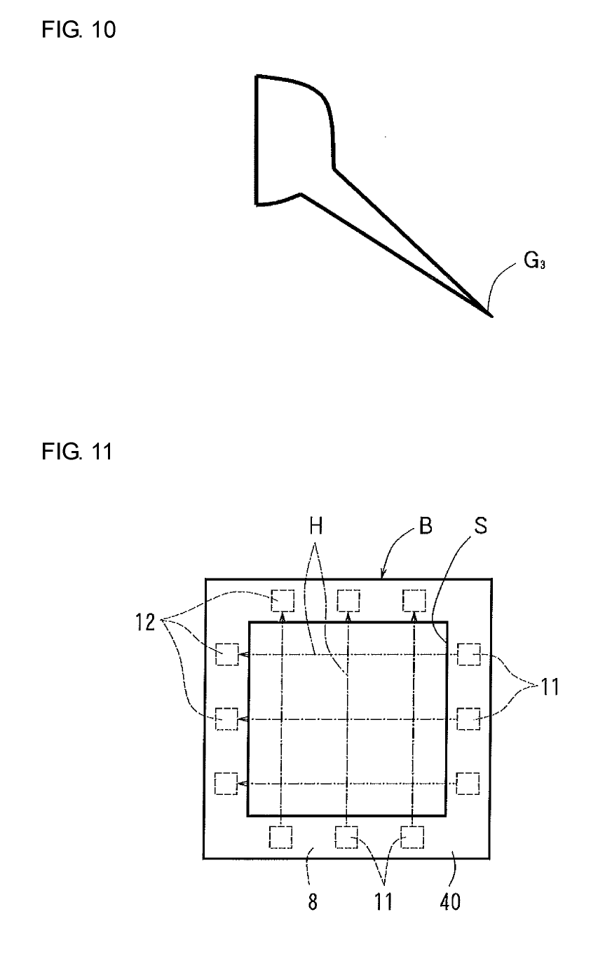

Another preferred embodiment of the input device is based on an assumption that a hand Q that holds a pen P is suspended in the air to be apart from paper sheet K during the input operation of a character or the like with the pen P onto the paper sheet K, as shown in FIG. 9. More specifically, when the hand Q is suspended in the air to be apart from the paper sheet K, there may be a case where a light-shielded part G2 of a part of the hand Q becomes smaller than a light-shielded part of a pen tip G1. At this time, the light-shielded part G2 of a part of the hand Q is mistakenly recognized as an input information whereas the light-shielded part of the pen tip G1 is recognized as unnecessary information. For example, if a hand Q is suspended in the air to be apart from paper sheet K when a character “D” is written, the light-shielded part G2 of a part of the hand Q is mistakenly recognized as an input information (with reference to FIG. 9). Due to this misrecognition, the character “D” is displayed as a distorted character together with the misrecognized part G3 as shown in FIG. 10. To prevent such misrecognition, a program (misrecognition preventing means) is incorporated in the aforementioned CPU in this preferred embodiment. When positions of a continuously recognized small light-shielded part are recognized as moving more than a predetermined distance, the program (misrecognition preventing means) judges such recognition as misrecognition and properly recognizes another light-shielded part staying at positions within the predetermined distance as input information, even if the other light-shielded part is larger. The aforementioned predetermined distance is generally set to be not more than a distance between a pen tip and a part of a hand Q (little finger, a base of the little finger and the like) which makes the light-shielded part G2, and may be set, for example, within a range from 5 to 20 mm. Other parts of this another preferred embodiment are similar to those of the aforementioned preferred embodiment (with reference to FIGS. 1 to 8), and like reference numerals and characters are used to designate the similar parts.

In this another preferred embodiment, since the input device comprises the misrecognition preventing means, the misrecognition like the above-mentioned does not occur and thus the input operation can be performed properly even when the hand Q is suspended in the air to be apart from paper sheet K during the input operation. Also, the action and the effect similar to the aforementioned preferred embodiment (with reference to FIGS. 1 to 8) can be attained with this another preferred embodiment.

For the purpose of improving the light transmission efficiency within the hollow input-use interior S of the rectangular frame-shaped optical waveguide W of the input device A according to the aforementioned preferred embodiments, the tips of the light-emitting cores 2a and the tips of the light-receiving cores 2b are formed as the lens portions, and the edge portion of the over cladding layer 3 covering the lens portions of the cores 2a and 2b is formed as the lens portion 3a. However, when the light transmission efficiency within the hollow input-use interior S is sufficient, the aforementioned lens portion(s) may be formed only in either the cores 2a and 2b or the over cladding layer 3, or be formed in neither the cores 2a and 2b nor the over cladding layer 3. When the aforementioned lens portions are not formed, a separate lens element may be prepared and provided along the periphery within the hollow input-use interior S of the aforementioned optical waveguide W.

FIG. 11 shows an input device according to still another preferred embodiment. The input device B according to this preferred embodiment includes: a rectangular frame-shaped retainer plate having the rectangular hollow input-use interior S; light-emitting diodes (light-emitting means) 11 disposed in juxtaposition on one of opposed peripheral sections of the retainer plate around the aforementioned hollow input-use interior S; and photodiodes (light-receiving means) 12 disposed in juxtaposition on the other peripheral section of the retainer plate. Light-emitting sections of the aforementioned light-emitting diodes 11 are opposed to light-receiving sections of the aforementioned photodiodes 12. The optical waveguide W (with reference to FIG. 1) is not provided in the input device B. It should be noted that the aforementioned light-emitting diodes 11 and the photodiodes 12 are mounted on the rectangular frame-shaped circuit board 8 provided on the surface of the aforementioned retainer plate. As in the aforementioned preferred embodiments (with reference to FIGS. 1 to 8), a CPU for controlling the input device B, an output module for outputting information inputted into the region within the aforementioned hollow input-use interior S, a storage means, a battery, and the like are mounted on the aforementioned circuit board 8. Further, the protective plate 40 is also provided. In FIG. 11, the number of light-emitting diodes 11 and the number of photodiodes 12 are shown as abbreviated.

Also in this preferred embodiment, the aforementioned light-emitting diodes 11 cause light beams H to travel in a lattice form in the region within the aforementioned hollow input-use interior S. When the pen P is moved in the region within the hollow input-use interior S, some of the light beams H traveling in the aforementioned lattice form are intercepted by the pen tip. The aforementioned photodiodes 12 sense the interception of light beams to thereby detect the path of the aforementioned pen tip. In other words, the input device B according to this preferred embodiment is used in a manner similar to that according to the aforementioned preferred embodiments (with reference to FIGS. 1 to 8), and is similar in function and effect to that according to the aforementioned preferred embodiment.

In the aforementioned preferred embodiments, the pen (a writing implement) P is used as the input element. The input element is an implement used for inputting a character and the like within the hollow input-use interior S. A narrow-tipped rod and the like may be used as the input element, if there is no need to write on a paper sheet.

Further, in the aforementioned preferred embodiments, the input devices A and B are used together with a PC, and the information inputted to the aforementioned input devices is displayed on a display for the aforementioned PC. Alternatively, functionality similar to that of the PC in the aforementioned preferred embodiments may be imparted to the aforementioned input devices A and B or to the aforementioned display, so that information is displayed on the display without using the PC.

Next, examples of the present invention will be described. It should be noted that the present invention is not limited to the examples.

### EXAMPLES

### Example 1

### Material for Formation of Under Cladding Layer

Component A: 75 parts by weight of an epoxy resin containing an alicyclic skeleton (EHPE 3150 manufactured by Daicel Chemical Industries, Ltd.).

Component B: 25 parts by weight of an epoxy-group-containing acrylic polymer (MARPROOF G-0150M manufactured by NOF Corporation).

Component C: four parts by weight of a photo-acid generator (CPI-200K manufactured by San-Apro Ltd.).

A material for the formation of an under cladding layer was prepared by dissolving these components A to C together with five parts by weight of an ultraviolet absorber (TINUVIN 479 manufactured by Ciba Japan K.K.) in cyclohexanone (a solvent).

### <Material for Formation of Cores>

Component D: 85 parts by weight of an epoxy resin containing a bisphenol A skeleton (157S70 manufactured by Japan Epoxy Resins Co., Ltd.).

Component E: five parts by weight of an epoxy resin containing a bisphenol A skeleton (EPIKOTE 828 manufactured by Japan Epoxy Resins Co., Ltd.).

Component F: 10 parts by weight of an epoxy-group-containing styrenic polymer (MARPROOF G-0250SP manufactured by NOF Corporation).

A material for the formation of cores was prepared by dissolving these components D to F and four parts by weight of the aforementioned component C in ethyl lactate.

### <Material for Formation of Over Cladding Layer>

Component G: 100 parts by weight of an epoxy resin having an alicyclic skeleton (EP4080E manufactured by ADEKA Corporation).

A material for the formation of an over cladding layer was prepared by mixing this component G and two parts by weight of the aforementioned component C together.

### <Production of Optical Waveguide>

The aforementioned material for the formation of the under cladding layer was applied to a surface of a substrate made of stainless steel (having a thickness of 50 μm). Thereafter, a heating treatment was performed at 160° C. for two minutes to form a photosensitive resin layer. Then, the aforementioned photosensitive resin layer was exposed to irradiation with ultraviolet light at an integrated dose of 1000 mJ/cm². Thus, the under cladding layer having a thickness of 10 μm (with a refractive index of 1.510 at a wavelength of 830 nm) was formed.

Then, the aforementioned material for the formation of the cores was applied to a surface of the aforementioned under cladding layer. Thereafter, a heating treatment was performed at 170° C. for three minutes to form a photosensitive resin layer. Next, exposure to irradiation with ultraviolet light at an integrated dose of 3000 mJ/cm² was performed through a photomask (with a gap of 100 μm). Subsequently, a heating treatment was performed at 120° C. for 10 minutes. Thereafter, development was performed using a developing solution (γ-butyrolactone) to dissolve away unexposed portions. Thereafter, a drying process was performed at 120° C. for five minutes. Thus, the cores having a width of 30 μm and a height of 50 μm (with a refractive index of 1.570 at a wavelength of 830 nm) were patterned.

A light-transmissive mold for the formation of the over cladding layer was prepared. This mold includes a cavity having a mold surface complementary in shape to the surface of the over cladding layer. The mold was placed on a molding stage, with the cavity positioned to face upward. Then, the cavity was filled with the aforementioned material for the formation of the over cladding layer.

Then, the cores patterned on the surface of the aforementioned under cladding layer were positioned relative to the cavity of the aforementioned mold. In that state, the aforementioned under cladding layer was pressed against the aforementioned mold, so that the aforementioned cores were immersed in the aforementioned material for the formation of the over cladding layer. In this state, exposure was performed at an integrated dose of 8000 mJ/cm² by irradiating the aforementioned material for the formation of the over cladding layer with ultraviolet light through the aforementioned mold. Thus, the over cladding layer was formed in which a portion thereof corresponding to the tips of the cores was in the form of a convex lens portion. The convex lens portion had a substantially quadrantal curved lens surface (having a radius of curvature of 1.4 mm) as seen in sectional side view.

Next, the aforementioned over cladding layer together with the aforementioned substrate, the under cladding layer and the cores was removed from the aforementioned mold.

Then, the aforementioned substrate was stripped from the under cladding layer. This provided each strip-shaped optical waveguide section (having a total thickness of 1 mm) including the under cladding layer, the cores, and the over cladding layer.

### <Production of Input Device>

Next, a circuit board was prepared, and a control means was produced by mounting a light-emitting element (SM85-2N001 manufactured by Optowell Co., Ltd.), a light-receiving element (S-10226 manufactured by Hamamatsu Photonics K.K.), a CMOS driving CPU, a crystal oscillator, a wireless module, two coin-type lithium cells (CR1216 having a thickness of 1.6 mm, a diameter of 1.25 mm, and a voltage of 3 V) and the like onto the circuit board. A program for the aforementioned CPU was that shown in the flow diagram of FIG. 3.

A rectangular frame-shaped retainer plate made of stainless steel (having a thickness of 0.5 mm) was prepared. The retainer plate had a hollow input-use interior in the form of a rectangle that was 30 cm in length and 30 cm in width. The strip-shaped optical waveguide sections were affixed to a portion of a surface of the aforementioned retainer plate which was outside the aforementioned hollow input-use interior to produce a rectangular frame-shaped optical waveguide, and the aforementioned control means was fixed thereon. At this time, the aforementioned light-emitting element was connected to light-emitting cores, and the aforementioned light-receiving element was connected to light-receiving cores. Thereafter, the top surface of the aforementioned over cladding layer except the lens portion and the fixed portion of the aforementioned control means were covered with a rectangular frame-shaped protective plate made of stainless steel (having a thickness of 0.5 mm). This provided an input device.

### Example 2

### Production of Input Device

A rectangular frame-shaped retainer plate similar to that in Example 1 described above was prepared. Light-emitting diodes (GL4800E0000F manufactured by Sharp Corporation) were disposed in juxtaposition on one of opposed peripheral sections of the retainer plate around the hollow input-use interior, and photodiodes (PD411PI2E00P manufactured by Sharp Corporation) were disposed in juxtaposition on the other peripheral section of the retainer plate. Also, in a manner similar to that in Example 1 described above, a control means was produced by mounting a CMOS driving CPU, a crystal oscillator, a wireless module, two coin-type lithium cells and the like onto a circuit board, and the control means was fixed on the aforementioned retainer plate. A program for the aforementioned CPU was that shown in the flow diagram of FIG. 3. The aforementioned light-emitting diodes, the photodiodes and the control means were covered with a rectangular frame-shaped protective plate made of stainless steel (having a thickness of 0.5 mm). This provided an input device.

### <Operation Check of Input Device>

A USB memory device with information such as a document stored therein, and a PC were prepared. The information stored in the USB memory device was displayed on a display for the PC by the use of the aforementioned PC. Software (a program) for converting coordinates in the region within the rectangular frame-shaped hollow input-use interior of the aforementioned input device into coordinates on the screen of the display to display a character or the like inputted by means of the input device on the display is incorporated in the aforementioned PC. The aforementioned PC included a receiving means so as to be able to receive radio waves (information) from the wireless module of the aforementioned input device. The aforementioned PC and the input device were connected for transmission of information therebetween by radio.

The input device in each of Examples 1 and 2 described above was placed on a paper sheet, with the stainless steel retainer plate downside. Next, a user held a pen in his/her hand, and wrote a character with the pen on the aforementioned paper sheet revealed in the region within the aforementioned hollow input-use interior. As a result, only the character was displayed while being superimposed on the information such as a document appearing on the aforementioned display, and the user's hand was not displayed.

The input device according to the present invention is applicable to the addition of new information such as characters, drawings, marks and the like to a document and the like appearing on a display.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. An input device, comprising:
a frame-shaped plate comprising a frame surrounding a space serving as a hollow input-use interior for input with an input element held by a hand, the frame-shaped plate including a pair of sections opposed to each other;
a light-emitting means provided on a first one of the opposed sections of the frame-shaped plate; and
a light-receiving means provided on a second one of the opposed sections of the frame-shaped plate and for receiving light beams emitted from the light-emitting means,
wherein the input device is configured such that the emitted light beams travel in a lattice form within the hollow input-use interior and such that some of the emitted light beams are intercepted by a tip input part of the input element within the hollow input-use interior to provide input information, and
wherein the input device further comprises an unnecessary part recognizing means for recognizing a larger light-shielded part as unnecessary information, based on a difference in light-shielded area, upon sensing a first light-shielded area where some of the emitted light beams are intercepted by the tip input part of the input element and a second light-shielded area where some of the emitted light beams are intercepted by the hand, the second light-shielded area being larger than the first light-shielded area.

2. The input device according to claim 1, wherein the light-shielded area having a length of not less than 5 mm is determined as the unnecessary information.

3. The input device according to claim 1,
wherein the input device further comprises a misrecognition preventing means for judging a light-shielded part of a hand in the air as a misrecognition, and for thereby recognizing the light-shielded part of the input element as an input information, when a light-shielded part of a tip input part of an input element and the light-shielded part of the hand in the air smaller than the light-shielded part of the tip input part of the input element are sensed, based on a positional difference of the light-shielded parts, the positional difference being such that the light-shielded part of the hand in the air is apart from a pre-recognized light-shielded part of the input element by more than a predetermined distance while the light-shielded part of the input element is within the predetermined distance from the pre-recognized light-shielded part of the input element.

4. The input device according to claim 1,
wherein the light-emitting means includes a light-emitting element, and a plurality of light-emitting cores of an optical waveguide, the light-emitting cores being connected to the light-emitting element;
wherein the light-receiving means includes a light-receiving element, and a plurality of light-receiving cores of the optical waveguide, the light-receiving cores being connected to the light-receiving element; and
wherein tips of the light-emitting cores and tips of the light-receiving cores are opposed to each other while being positioned on inner edges of the frame-shaped plate.

5. The input device according to claim 1,
wherein the light-emitting means includes a plurality of light-emitting elements;
wherein the light-receiving means includes a plurality of light-receiving elements; and
wherein the light-emitting elements and the light-receiving elements are opposed to each other while being positioned on inner edges of the frame-shaped plate.

6. The input device according to claim 2,
wherein the input device further comprises a misrecognition preventing means for judging a light-shielded part of a hand in the air as a misrecognition, and for thereby recognizing the light-shielded part of the input element as an input information, when a light-shielded part of a tip input part of an input element and the light-shielded part of the hand in the air smaller than the light-shielded part of the tip input part of the input element are sensed, based on a positional difference of the light-shielded parts, the positional difference being such that the light-shielded part of the hand in the air is apart from a pre-recognized light-shielded part of the input element by more than a predetermined distance while the light-shielded part of the input element is within the predetermined distance from the pre-recognized light-shielded part of the input element.

7. The input device according to claim 2,
wherein the light-emitting means includes a light-emitting element, and a plurality of light-emitting cores of an optical waveguide, the light-emitting cores being connected to the light-emitting element;
wherein the light-receiving means includes a light-receiving element, and a plurality of light-receiving cores of the optical waveguide, the light-receiving cores being connected to the light-receiving element; and
wherein tips of the light-emitting cores and tips of the light-receiving cores are opposed to each other while being positioned on inner edges of the frame-shaped plate.

8. The input device according to claim 2,
wherein the light-emitting means includes a plurality of light-emitting elements;
wherein the light-receiving means includes a plurality of light-receiving elements; and
wherein the light-emitting elements and the light-receiving elements are opposed to each other while being positioned on inner edges of the frame-shaped plate.

9. The input device according to claim 3,
wherein the light-emitting means includes a light-emitting element, and a plurality of light-emitting cores of an optical waveguide, the light-emitting cores being connected to the light-emitting element;
wherein the light-receiving means includes a light-receiving element, and a plurality of light-receiving cores of the optical waveguide, the light-receiving cores being connected to the light-receiving element; and
wherein tips of the light-emitting cores and tips of the light-receiving cores are opposed to each other while being positioned on inner edges of the frame-shaped plate.

10. The input device according to claim 3,
wherein the light-emitting means includes a plurality of light-emitting elements;
wherein the light-receiving means includes a plurality of light-receiving elements; and
wherein the light-emitting elements and the light-receiving elements are opposed to each other while being positioned on inner edges of the frame-shaped plate.
